(19) United States
(12) Patent Application Publication
(10) Pub. No.: US 2010/0104022 A1
(43) Pub. Date: Apr. 29, 2010

(54) Method and apparatus for video processing using macroblock mode refinement

(76) Inventors: Chanchal Chatterjee, Encinitas, CA (US); Robert Owen Eifrig, San Diego, CA (US)

Correspondence Address: GAZDZINSKI & ASSOCIATES, PC, 16644 WEST BERNARDO DRIVE, SUITE 201, SAN DIEGO, CA, 92127, US

(21) Appl. No.: 12/396,393

(22) Filed: Mar. 2, 2009

Related U.S. Application Data
(60) Provisional application No. 61/197,216, filed on Oct. 24, 2008.
(60) Provisional application No. 61/197,217, filed on Oct. 24, 2008.

(51) Int. Cl. H04N 7/64; H04N 7/24

(52) U.S. Cl. 375/240.24; 375/E07.279; 375/E07.02

(57) ABSTRACT

Apparatus and methods for processing (e.g., transrating) one or more compressed video bitstreams including mode refinement analysis. In one embodiment, a method of transrating a digital video picture having a plurality of input macroblocks, each input macroblock having at least first and second attributes (e.g., slice type, encoding mode, and a “skipped” mode) is disclosed. In one variant, the method comprises generating an output macroblock corresponding to each input macroblock, with each of the output macroblocks having the first and second attributes. For each output macroblock having a first value for the first attribute (e.g., slice type), the second attribute (e.g., encoding mode) is decided at least in part by evaluating one or more error criteria, the error criteria being responsive to the second attribute of a corresponding input macroblock.

### PRIORITY AND RELATED APPLICATIONS

This application claims priority to co-owned and co-pending U.S. provisional patent application Ser. No. 61/197,216 filed Oct. 24, 2008 entitled “Method And Apparatus For Transrating Compressed Digital Video”, and U.S. provisional patent application Ser. No. 61/197,217 filed Oct. 24, 2008 entitled “Video Transrating Method and Apparatus Using Macroblock Mode Refinement”, which are incorporated herein by reference in its entirety. This application is also related to co-owned and co-pending U.S. patent application Ser. No. 12/322,887 filed Feb. 9, 2009 and entitled “Method And Apparatus For Transrating Compressed Digital Video”, which is incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The present invention relates generally to the field of digital video encoding, and more particularly in one exemplary aspect to methods and systems of changing bitrate of a digital video bitstream.

2. Description of the Related Technology

Since the advent of Moving Pictures Expert Group (MPEG)'s digital audio/video encoding specifications, digital video is ubiquitously used in today's information and entertainment networks. Example networks include satellite broadcast networks, digital cable networks, over-the-air television broadcasting networks, and the Internet

Furthermore, several consumer electronics products that utilize digital audio/video have been introduced in the recent years. Some examples include digital versatile disk (DVD)), MP3 audio players, digital video cameras, etc.

Such proliferation of digital video networks and consumer products has led to an increased need for a variety of products and methods that perform storage or processing of digital video. One such example of video processing is changing the bitrate of a compressed video bitstream. Such processing may be used, for example, to change the bitrate of a digital video program stored on a personal video recorder (PVR) at the bitrate received from a broadcast video network, to the bitrate of a home network to which the program is being sent. Changing the bitrate of a video program is also performed in other video distribution networks such as digital cable networks, and Internet protocol television (IPTV) distribution network.

In conventional approaches, one simple way to change the bitrate is by decoding received video bitstream into an uncompressed video stream, and then re-encoding the uncompressed video to a desired output rate. While conceptually easy, this method is practically inefficient because of the need to implement a computationally expensive video encoder to perform bitrate changes, i.e., transrating.

Several transrating techniques have been proposed for the MPEG-2 video compression format With the recent introduction of advanced video codecs such as VC-1, also known as the 421M video encoding standard of the Society of Motion Picture and Television Engineering (SMPTE), and H.264, the problem of transrating has become even more complex. Broadly speaking, it takes much higher amounts of computation to encode video to one of the advanced video codecs. Similarly, decoding an advanced video codec bitstream is computationally more intensive than first generation video encoding standards. As a result of increased complexity, transrating requires higher amounts of computation. Furthermore, due to wide scale proliferation of multiple video encoding schemes (e.g., VC-1 and H.264), seamless functioning of consumer video equipment requires transcoding from one encoding standard to another, besides transrating to an appropriate bitrate.

While the computational complexity requirements have increased due to sophisticated video compression techniques, the need for less complex and efficient transrating solutions has also increased due to the proliferation of digital video deployments, and increased number of applications where transrating is employed in a digital video system. Many consumer devices, which are traditionally cost sensitive, also require transrating.

Hence, there is a salient need for improved methods and apparatus that enable lower complexity transrating of digital video streams in an efficient and cost effective manner. Such improved methods and apparatus will also ideally be compatible with extant (legacy) processing platforms and protocols, as well as with newer and fuiture implementations.

### SUMMARY OF THE INVENTION

The present invention satisfies the foregoing needs by providing improved methods and apparatus for video processing, including transrating and transcoding.

In a first aspect, a method of transrating a digital video picture is disclosed. In one embodiment, the method comprises: representing the digital video picture as a plurality of input macroblocks, each input macroblock having at least first and second attributes; and generating, corresponding to each input macroblock, an output macroblock, each of the output macroblocks having the at least first and second attributes. In one variant, for each output macroblock having a first value for the first attribute, the second attribute is decided at least in part by evaluating one or more error criteria, the one or more error criteria responsive to the second attribute of a corresponding input macroblock.

In one variant, each of the input macroblocks and output macroblocks comprises a third attribute; and the third attribute of the output macroblock is responsive to a spatial and a temporal location of the output macroblock.

In another variant, the digital video picture comprises a picture encoding attribute.

In yet another variant, the first attribute comprises a slice type, the second attribute comprises an encoding mode, and the third attribute comprises a skipped mode, and the skipped mode is one of skipped and non-skipped.

In another variant, if the encoding mode is of a first predetermined type, then the skipped mode of the output macroblock is further responsive to the skipped mode of a second input macroblock. The input macroblock and the second input macroblock together comprise spatially co-located top and bottom macroblocks in the digital video picture.

In a further variant, the first attribute comprises a slice type, and the second attribute comprises an encoding mode. For instance, the first value may indicate a slice type relating to an intra prediction.

In still another variant, the one or more error criteria comprise one of: (i) a sum of absolute differences (SAD), or (ii) a sum of absolute transformed differences (SATD), between the input macroblock and the output macroblock.

In a second aspect of the invention, a computer-implemented method of processing a macroblock of an input video picture is disclosed. In one embodiment, the method comprises implementing logic where if the input video picture is intra encoded, then assigning an intra encoding mode for the macroblock. This mode assignment is conducted by at least: calculating a transrating error for a plurality of candidate output macroblocks having an intra encoding mode; and assigning to the macroblock the intra encoding mode of a candidate output macroblock having the minimum value of the transrating error. If the input video picture is not intra encoded, then the macroblock as a “skipped” macroblock is encoded based at least in part on at least first, second and third attributes associated with the macroblock.

In one variant, the first second and third attributes comprise: (i) a spatial position of the macroblock, (ii) a top/bottom polarity of the macroblock, and (iii) a run length encoding scheme used for encoding the macroblock. For instance, the run length encoding scheme may comprise a context adaptive binary arithmetic coding scheme (CABAC).

In another variant, at least one of the pluralities of candidate output macroblocks has a pixel width greater than a pixel width of the macroblock.

In a further variant, at least one of the pluralities of candidate output macroblocks has a pixel width twice that of a pixel width of the macroblock.

In a third aspect of the invention, apparatus configured to process a digital video image is disclosed. In one embodiment, the image is represented as a plurality of input macroblocks, each the input macroblock having at least first and second attributes, and the apparatus comprises: a first interface adapted to receive at least the input macroblocks of the image; logic configured to generate, corresponding to each input macroblock, an output macroblock, each of the output macroblocks having the at least first and second attributes; and a second interface adapted to output at least the output macroblocks to a device. For each output macroblock having a first value for the first attribute, the second attribute is decided by the logic at least in part through evaluation of one or more error criteria, the one or more error criteria being related to the second attribute of a corresponding input macroblock.

In one variant, each of the output macroblocks comprises a third attribute responsive to a spatial and a temporal location of that output macroblock.

In another variant, the first interface comprises a high-speed serialized bus protocol interface, and at least a portion of the logic is hard-coded into an integrated circuit of the apparatus.

In a further variant, the apparatus comprises a portable media device (PMD) having a battery and a display device, the display device allowing for viewing of the processed digital image. The PMD further comprises for example NAND flash memory adapted to store the processed digital image.

In a fourth aspect of the invention, an integrated circuit is disclosed. In one embodiment, the integrated circuit comprises: at least one semi conductive die; a first interface adapted to receive data relating to one or more video images represented as a plurality of input macroblocks, each the input macroblock having at least first and second attributes; at least one of computer instructions, firmware or hardware configured to generate, corresponding to each input macroblock, an output macroblock having the at least first and second attributes; and a second interface adapted to output at least the output macroblocks. For macroblocks having a first value for the first attribute, the second attribute is decided in one variant by the at least one of computer instructions, firmware or hardware at least in part through evaluation error criteria related to the second attribute of a corresponding input macroblock.

In one variant, the at Least one semi conductive die comprises a single silicon-based die, and the integrated circuit comprises a system-on-chip (SoC) integrated circuit having at least one digital processor in communication with a memory, and the first and second interfaces, processor and memory are all disposed on the single die.

In a fifth aspect of the invention, a method of transrating video content comprising a plurality of macroblocks is disclosed. In one embodiment, the method comprises: receiving the plurality of input macroblocks; replacing exact transrating calculations relating to processing the macroblocks with approximations, the approximations requiring less resources to generate than the exact calculations; and generating a plurality of transrated output macroblocks based at least in part on the plurality of input macroblocks and the approximations.

In one variant the visual quality of the transrated output macroblocks is not perceptibly degraded with respect to the visual quality of transrated output macroblocks generated using the exact calculations.

These and other features, aspects and advantages of the present invention will become better understood with reference to the following drawings, description and claims.

### BRIEF DESCRIPTION OF THE DRAWINGS

FIG. 1 is a block diagram showing an exemplary transrating system, in accordance with an embodiment of the present invention.

FIG. 2 is a block diagram showing an exemplary transrating system comprising an encoder and a decoder, in accordance with an embodiment of the present invention.

FIG. 3 is a block diagram showing an exemplary transrating system comprising an H.264 decoder and an H.264 encoder, in accordance with an embodiment of the present invention.

FIG. 4 is a block diagram showing an exemplary transrating system without motion estimation, intra decisions, and mode decision, in accordance with an embodiment of the present invention.

FIG. 5 is a block diagram showing an exemplary transrating system without motion estimation, intra decisions, mode decision, and deblocking, in accordance with an embodiment of the present invention.

FIG. 6 is a flow chart showing an exemplary embodiment of the method of skipped and non-skipped transitions.

FIG. 6A is a flow chart showing an exemplary embodiment of the method of handling MBAFF doNotSkip Flag Settings.

FIG. 6B is a flow chart showing an exemplary embodiment of the method of handling skipped to non-skipped transitions.

FIG. 6C is a flow chart showing an exemplary embodiment of the method of handling non-skipped to skipped transitions.

FIG. 7 is a flow chart showing an exemplary method of deciding among Intra 4×4, Intra 8×8 and Intra 16×16 transitions.

FIG. 8 is a block diagram showing an exemplary method of generating new modes for macroblocks.

FIG. 9 is a block diagram of an exemplary implementation of a transrating apparatus in accordance with an embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

As used herein, “video bitstream” refers without limitation to a digital format representation of a video signal that may include related or unrelated audio and data signals.

As used herein, “transrating” refers without limitation to the process of bit-rate transformation. It changes the input bit-rate to a new bit-rate which can be constant or variable according to a function of time or satisfying a certain criteria. The new bitrate can be user-defined, or automatically determined by a computational process such as statistical multiplexing or rate control.

As used herein, “transcoding” refers without limitation to the conversion of a video bitstream (including audio, video and ancillary data such as closed captioning, user data and teletext data) from one coded representation to another coded representation. The conversion may change one or more attributes of the multimedia stream such as the bitrate, resolution, frame rate, color space representation, and other well-known attributes.

As used herein, the term “macroblock” (MB) refers without limitation to a two dimensional subset of pixels representing a video signal. A macroblock may or may not be comprised of contiguous pixels from the video and may or may not include equal number of lines and samples per line. A preferred embodiment of a macroblock comprises an area 16 lines wide and 16 samples per line.

### Transrating Overview

In one salient aspect, the present invention takes advantage of temporal and spatial correlation of video signals to reduce the complexity of transrating a video bitstream. The video signal underlying a video bitstream has the notion of time sequenced video frames. For example, National Television System Committee (NTSC) signal broadcast in analog television networks in the United States is made up of 29.97=30/1.001 frames per second video signal. Furthermore, each video picture is made up of two-dimensional arrays of pixels. In one embodiment, the present invention contemplates processing video bitstreams representing smaller units of a frame; these smaller units are referred to herein as macroblocks (MB), although other nomenclature may be used. An MB may comprise for example a rectangular area of 16×16 pixels, each pixel being represented by a value or a set of values. For instance, a pixel may have a luminance value and two color values (Cb and Cr). Other possible implementations are possible and will be recognized by those of ordinary skill in the video processing field given the present disclosure.

In a video bitstream represents a video signal in a sequence that comprises video pictures, grouped together in sequence of macroblocks (MBs), one aspect of the present invention applies transrating techniques to exploit correlations among MBs that are spatially near to each other and to video pictures that are temporally near to each other. In particular, exemplary implementations of the present invention may use MB-level encoding decisions from spatially nearby MBs and picture-level encoding decisions from temporal neighbors to trade off complexity of transrating. In one particular embodiment, the technique that encodes MBs as “skipped” or “non-skipped” is utilized. Representation of a skipped MB requires very few bits in the digital video bitstream (typically 1 bit, although other numbers of bits can be used), and generally indicates to the decoder that while decoding, the decoder can use value of a previously encoded M in place of the skipped MB. Decisions regarding skipped MBs are especially useful in transrating and transcoding because they offer a comparatively direct method of controlling the number of bits required to represent a digital video picture or image (at the expense of visual quality of that picture). For example, having a higher number of skipped MBs in a picture will typically result in a reduced bitrate, but may result in at least somewhat degraded quality of the video because skipped MBs carry visually identical information as a previously encoded MB.

### Description of Exemplary Embodiments

Exemplary embodiments of the various apparatus and methods according to the present invention are now described in detail.

It will be recognized that while the exemplary embodiments of the invention are described herein primarily in the context of the H.264 codec syntax referenced above, the invention is in no way so limited, and in fact may be applied broadly across various different codec paradigms and syntaxes.

### Exemplary Apparatus

One common architectural concept underlying certain aspects and embodiments of the invention relates to use of a “three stage” process—i.e., (i) an input processing stage, (ii) an intermediate format processing stage, and (iii) an output processing stage. In one embodiment, the input processing stage comprises both a decompression stage that takes an input bitstream and produces an intermediate format signal, and a parsing stage that parses certain fields of the bitstream to make them available to the output processing stage.

The intermediate format processing stage performs signal processing operations, described below in greater detail, in order to condition the signal for transrating.

Finally, the output processing stage converts the processed intermediate format signal to produce the output bitstream, which comprises the transrated version of the input bitstream in accordance with one or more quality metrics such as e.g., a target bitrate and/or a target quality.

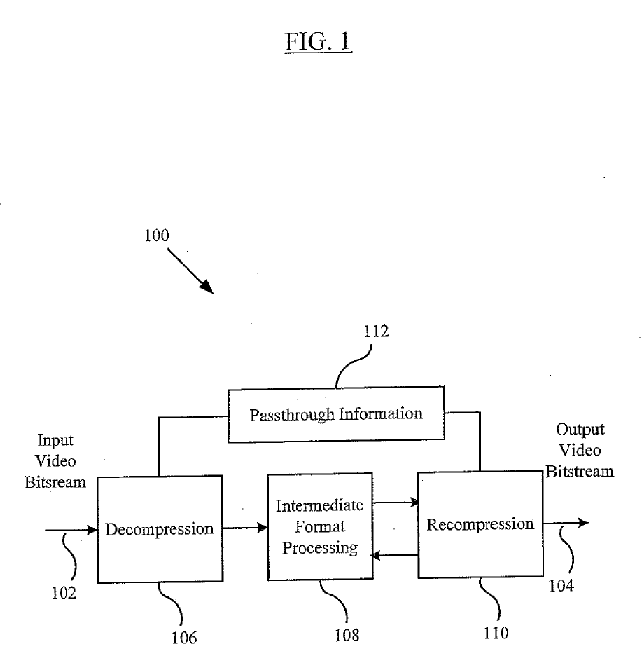

FIG. 1 shows one embodiment of a generalized transcoding system 100 according to the invention, including the aforementioned three-stage architecture. An input video bitstream 102 with a first bitrate is transcoded into an output video bitstream 104 with a second bitrate. The input video bitstream 102 may be, for example, conformant to the H.264 or MPEG-4 AVC (Advanced Video Coding) syntax, or the VC-1 syntax. Similarly, the output video bitstream 104 may conform to a video syntax. Generally, when the syntax used by the input video bitstream 102 and the output video bitstream 104 are same, then the transcoding operation is only performing transrating function, as defined above. The input video bitstream 102 is converted into an intermediate format using decompression 106. In various implementations, the decompression operation 106 may include varying degrees of processing, depending on the tradeoff between qualities and processing complexity desired. In one embodiment, this information is hard-coded into the apparatus, although other approaches may be used as will be recognized by those of ordinary skill. The intermediate format may for example be uncompressed video, or video arranged as macroblocks that have been decoded through a decoder (such as an entropy decoder of the type well known in the video processing arts). Some information from the input video bitstream may be parsed and extracted in module 112 to be copied from the input to the output video bitstream. This information, referred to as “pass-through information” herein, may contain for example syntactical elements such as header syntax, user data that is not being transrated, and/or system information (SI) tables, etc. This information may further include additional spatial or temporal information from the input video bitstream 102. The intermediate format signal may be further processed to facilitate transcoding (or transrating) as further described below. The processed signal is then compressed (also called recompressed because the input video signal 102 was in compressed form) to produce the output video bitstream 104. The recompression also uses the information parsed and extracted in module 112.

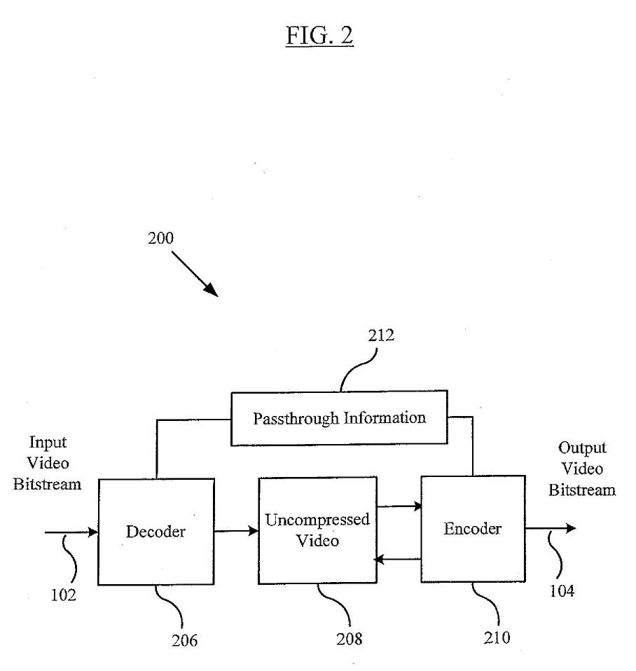

FIG. 2 shows an exemplary transcoding system 200 showing a decoder module 206 that may receive an input video bitstream 102. The system 200 decodes input video bitstream 102 in a decoder module 206 to produce uncompressed digital video. The uncompressed digital video, which is in the intermediate video format for the system 200, may be processed in the uncompressed video module 208 to aid the transrating operation. The intermediate format processing may include operations such as e.g., filtering the uncompressed video to preserve visual quality at the output of the transrating. In one embodiment, the intermediate format processing includes removing redundancies in the uncompressed video (e.g., 3:2 pull-down and fade detection), or generating information such as scene changes that may be useful for encoding performed in the encoder 210. In the illustrated system 200, the pass-through information 212 may comprise for example of user data and various header fields such as a sequence-level header, or a picture-level header or sub-picture level header.

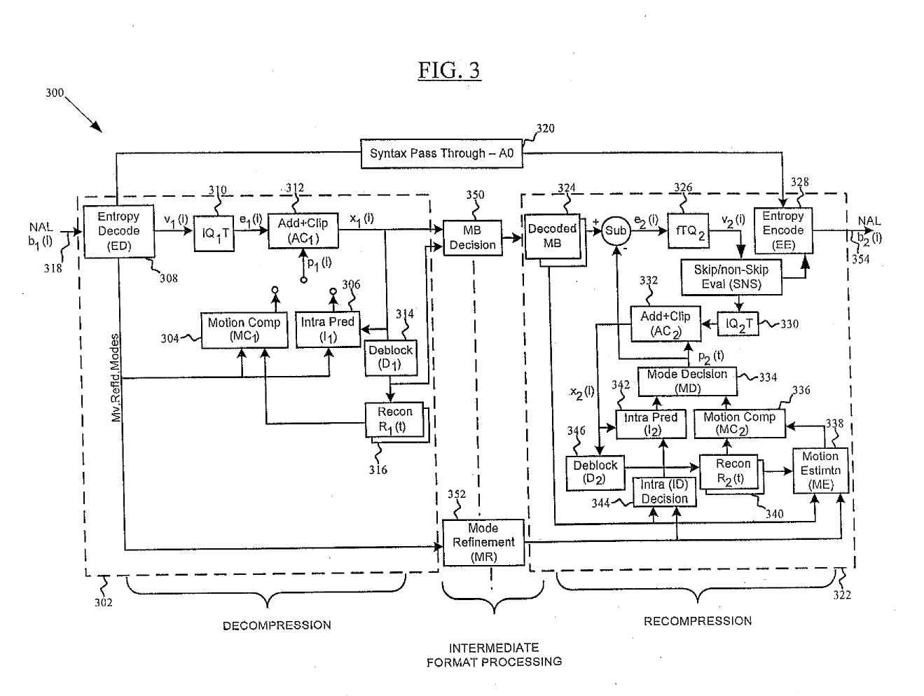

FIG. 3 shows an exemplary embodiment 300 of the transrating system 200 for transrating a video bitstream compliant with an advanced video codec specification (such as H.264 or VC-1, although the invention is in no way limited to these “advanced” codecs). The transrater 300 includes a decompression module 302, and intermediate format processing module 350, and a recompression module 322, with the syntax pass-through operation performed in module 320. In one exemplary embodiment, the decompression sub-system 302 includes an entropy decoder 308 that performs lossless decoding of input bitstream to an output bitstream, denoted for a given MB as v₁(i) in FIG. 3. The index “i” represents a sequence number of the picture being processed from the input video bitstream. The output of the entropy decoder 308 may be used by the inverse quantizer and inverse transformer 310 to produce a residual signal e₁(i) and the motion compensation module 304. The output of the entropy decoder 308 may also be used by the syntax pass-through module 320, to produce pass-through bits that are communicated to the recompression module 322. The add/clip module 312 may process output signal e₁(i) from the inverse quantizer and inverse transformer 310 and a predicted MB signal p₁(i), to produce an estimate of the reconstructed undeblocked uncompressed video pixel values x₁(i).

The intermediate format processing in the illustrated transrater 300 comprises a MB decision module 350. For processing in module 350, the transrater 300 may have most or substantially all pixels of a picture available in decompressed form. In one embodiment, the transrater 300 may make decisions regarding how to code each MB by processing the decompressed video. In another embodiment, the transrater 300 may preserve the MB modes as encoded in the incoming video bitstream.

In yet another embodiment, the transrater 300 may change MB decisions to help maintain video quality at the output of the transrater 300. This change in MB decisions may also be responsive to the target output bitrate. For example, to reduce number of bits generated by encoding a MB in the output video bitstream, the transrater 300 may favor encoding more MBs as inter-MBs instead of intra-MBs.

The recompression module 322 re-encodes the uncompressed video back to a compressed video bitstream by performing a recompression operation. The recompression may be performed such that the output video bitstream 354 comprises format compliant to an advanced video encoding standard such as e.g., H.264/MPEG-4 or VC-1. Because the input video bitstream is converted into an intermediate uncompressed video format, transrater 300 may advantageously be used to also change the bitstream standard. For example, input video bitstream 102 may be in H.264 compression format and the output video bitstream 104 may be in the VC-1 compression format, or vice-a-versa. The recompression module 322 includes a module 324 for processing decoded macroblocks, and a forward quantizer and forward transformer 326 that quantizes and transforms the residual output e₂(i) generated from subtraction of the predicted signal p₂(t) from the output of the decoded MB module 324. The forward quantizer and forward transformer module 326 is used to quantize and transform coded residual signal for the decoder loop inside the recompression module 322. The decoder loop also includes an add/clip module 332, and a deblocking module 346 that provides input to the reconstruction module 340. The output predicted pictures from the reconstruction module 340 are used by a motion estimation module 338. The motion estimation module 338 receives motion vector information from the entropy decoder 308 (i.e., via the mode refinement module 352) to help speed up estimation of accurate motion vectors. A motion compensation module 336 is used to perform motion compensation in the recompression module 322. The motion compensation module 336 can be functionally different from the motion compensation module 304. The latter does a single motion compensation for a given mode specified in the compressed bitstream. In 336, the motion compensation module does motion compensation for one or more modes and passes on the results to the mode decision engine 334 to decide which mode to choose among the many tried. The output of motion compensation is fed into a mode decision module 334, along with the output of an intra prediction module 342. The mode decision module 334, in turn drives the inputs to the add/clip module 332.

In FIG. 3, functional blocks useful for the description of the present invention are shown. Practitioners of ordinary skill in the art will recognize that the decompression sub-system 302 is an exemplary H.264 decoder, and embodiments may contain additional functional blocks connected in a variety of different ways to produce uncompressed digital video from an H.264 video bitstream. In addition to performing decompression, the embodiment of the apparatus 300 of FIG. 3 also extracts pass-through information (e.g., syntax) in a functional block 320. The system represented in FIG. 3 is called “A0” subsequently herein.

### Alternate Embodiment (A1)

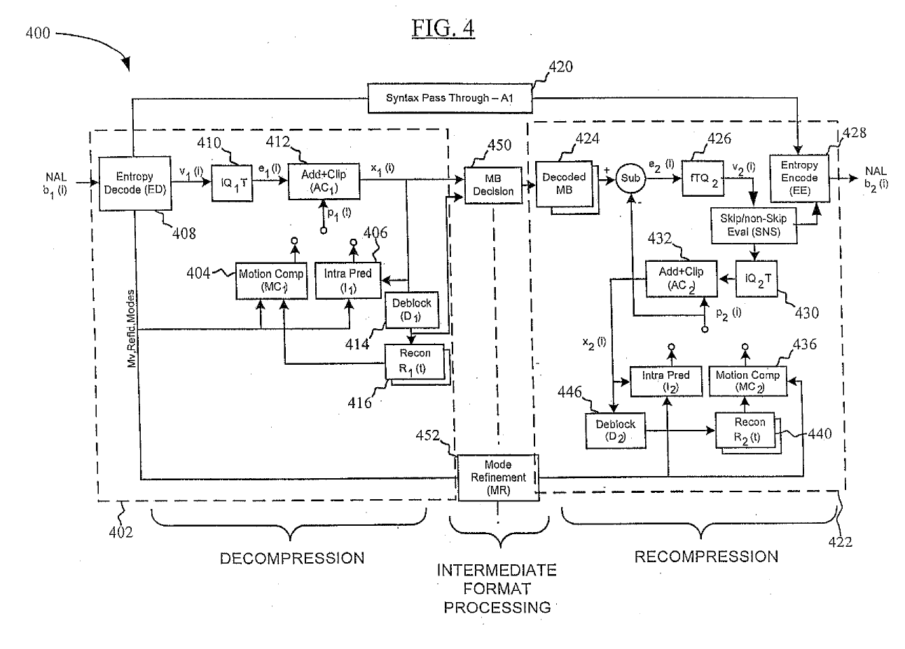

FIG. 4 shows another embodiment 400 (herein referred to as A1 transrater) of a transrating apparatus in accordance with the present invention. In this embodiment 400, the encoding and decoding processing modules are simplified to eliminate the intra decision, motion estimation and mode decision components of the encoder (see FIG. 3) which are computationally intensive. The motion compensator is also greatly simplified. The decompression subsystem 402 comprises a motion compensation module 404 which gets its input from an entropy decode module 408 that produces motion vectors and MB modes. Intra-prediction is performed in the intra-prediction module 406. The output v₁(i) of entropy decode module 408 is input to an inverse quantizer and inverse transformer module 410 that produces a residual signal e₁(i). The residual signal e₁(i) is processed by an add/clip module 412 to produce intermediate video data x₁(i) used by a deblock module D₁ 414 and the intra-prediction module 406. The decompression subsystem 402 further comprises a reconstruction module 416. The intermediate format processing is performed in a MB decision module 450, further described below.

The compression subsystem 422 of the illustrated embodiment comprises a decoded NM processing module 424 that receives decisions from MB decision module 450 and produces decoded MB pixel values. A residual signal, e₂(i) is generated by subtracting output of the decoded MB processing module 424 and predicted pixel values p₂(i). The residual signal e₂(i) is then quantized and transformed in module 426 to produce signal v₂(i) used for entropy encoding to generate the output video bitstream 104. An inverse quantizer and inverse transformer module 430 is used to de-quantize signal v₂(i). The output of the inverse quantizer and inverse transformer module 430 is then processed through an add/clip module 432 to produce a signal x₂(i) that is input to a deblocking module 446. The reconstruction module 440 is used to reconstruct pixels in uncompressed video format from output of the deblocking module 446. The uncompressed video is processed in a motion compensation module MC₂ 436.

As previously noted, the apparatus 400 of FIG. 4 does not have an intra decision, mode decision, and motion estimation module. This approach advantageously saves both computational complexity and bus bandwidth required to process video signals by eliminating the need to calculate mode decisions, motion vectors, and reference indices when transferring video in intermediate format from the decoder to the encoder stages. This saves considerable amounts of logic, memory and bus bandwidth, which would otherwise be required to support these functions. Experimental data generated by the inventor(s) hereof shows that the A1 transrater 400 preserves video quality compared to A0 at the output for up to as much as a 30% reduction in bitrate at the output (i.e., quality can be substantially maintained with up to 30% reduction in bitrate).

The intra decision module 344 and motion estimation module 338 and mode decision module 334 used in the transrater 300 of FIG. 3 are not needed in the transrater 400 of FIG. 4. The intra decision module 344 typically decides which modes to use since there can be intra 16×16 modes, intra 4×4 modes and intra 8×8 modes in high profile. Besides, the motion compensation module 436 is vastly simpler in 400 when compared to module 336 in 300. The transrater 400 advantageously offers several implementation efficiencies without compromising the visual quality of resulting transrater bitstream. For example, the absence of the motion estimation module 338 can provide significantly reduced complexity of implementation, including reduced bus bandwidth requirements due to elimination of the motion vector search.

Table 1 shows exemplary pass-through syntax that may be processed in the module 400:

TABLE 1
A1 Passthrough Syntax

| | |
|---|---|
| 1 | Picture Type |
| 2 | SPS and PPS syntax |
| 3 | Slice header and slice data syntax |
| 4 | MB layer syntax |
| 5 | MB prediction syntax |
| 6 | Deblock parameters |
| | Mode decisions: |
| | Picture level field/frame decisions |
| | Inter/intra decisions |
| | Intra 16 × 16, 8 × 8, 4 × 4 modes |
| | Inter partition type |
| | Motion vector and reference indices |
| 7 | Mode refinement parameters |

### Exemplary Bandwidth Calculation

If the video bitstream processed by a transrater represents interlaced high definition video at 1920 pixels×1088 lines resolution at 30 frames per second, the bus bandwidth required for data read/writes may include for example the values shown in Table 2 below:

TABLE 2

| | Bandwidth | |
|---|---|---|
| Item | (bytes/second) | |
| Writing a reference picture out: 1920 | 94,003,200 | |
| wide × 1088 high (corresponding to 68 MB | | |
| rows) × 1.5 bytes per pixels (luma + | | |
| one-fourth chroma components) × 30 frames/sec | | |
| Reading a reference in: 16 Partitions per | 775,526,400 | |
| MB × (9 × 9Y + 2 × 3 × 3Cb/Cr) support × | | |
| 8160 MBs/frame × 30 frames/sec × 2 refs | | |
| Coloc out: 8160 MBs × 160 B × 30 frames/sec | 39,168,000 | |
| Coloc in: 8160 MBs × 160 B × 30 frames/sec | 39,168,000 | |
| Intra Pred: 2 in/out × 1920 wide × 2 color × | 230,400 | B/sec |
| 30 frames/sec | | |
| NeighborHood: 2 in/out × 34 B (Block | 16,646,400 | B/sec |
| Info + Cb/CrCoefs) × 8160 MBs/frame × | | |
| 30 frames/sec | | |
| Total bandwidth = 2 (dec + enc) × | 1,929,484,800 | |
| 964,742,400 B/sec | | |

As shown in FIG. 4 and described above, the transrater A1 400 may in one embodiment use the deblocking function four times—(1) the original encoder, (2) the decoder of the transrater, (3) the partial encoder of the transrater, and (4) the final decoder (such as a set-top box) at a consumer's premises in a digital video distribution network. This design may be simplified, however, by removing the deblocking at the steps (2) and (3), but passing on the deblocking information for use in the final decoder in step (4) above. This simplification can potentially cause minor drifts. However, test implementations produced by the inventor(s) hereof indicate that removing the deblocking from architecture A1 simplifies the design with minor picture quality losses for I pictures.

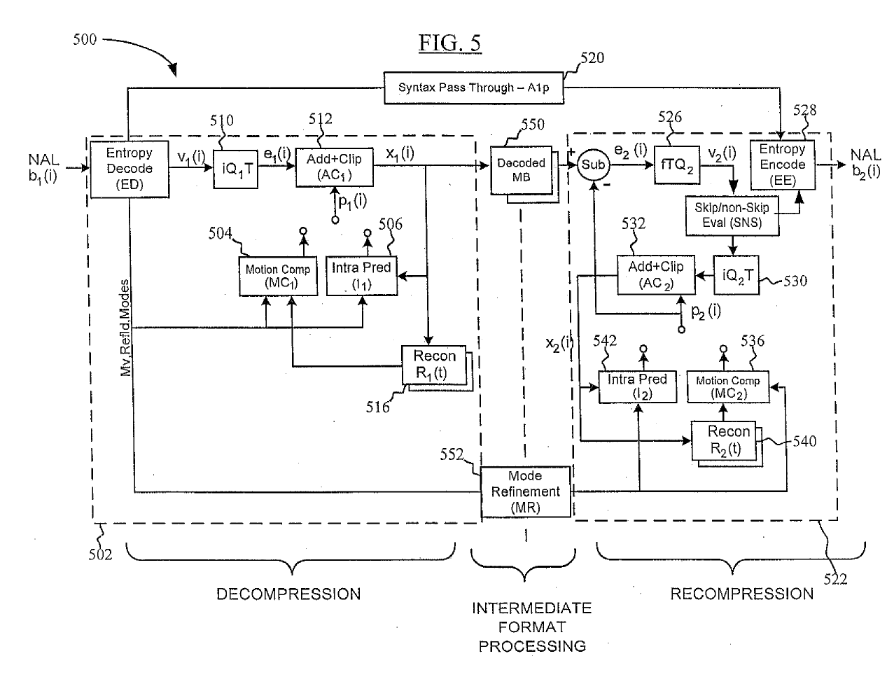

FIG. 5 is a block diagram showing an exemplary embodiment of a transrating system, hereinafter referred to as the A1p transrater 500. The decompression module 502 comprises a motion compensation module 504, an intra-prediction module 506, an entropy decoder, an inverse quantizer and inverse transformer 510, an add/clip module 512, and a reconstruction module 516. The intermediate format processing module 552 includes a processing module for decoded MBs 550, and a mode refinement module 552. The illustrated embodiment of the compression module 522 comprises a quantizer and transformer 526, an entropy encoder 528, an inverse quantizer and inverse transformer module 530, an add/clip module 532, a motion compensation module 536, an intra prediction module 542, and a reconstruction module 540.

Advantages of the A1p 500 embodiment over the A1 400 embodiment include: (i) less logic due to the absence of deblocking at the decoder and partial encoder stages, (ii) less bus bandwidth out of the device to external memory (e.g., by approximately 62 megabytes per second in one implementation), (iii) less bus bandwidth into the device from external memory (e.g., by approximately 62 megabytes per second), and (iv) less use of internal memory (e.g., by approximately 2 megabytes).

### Transrating Quality Management

In one embodiment, the present invention utilizes a mode refinement function that is part of the intermediate processing logic 108, and processes the intermediate format video signals produced by the decoder stage 106 of the apparatus of FIG. 1 previously described. It is noted that the various modules shown in the exemplary decoder and encoder stages of the apparatus of FIGS. 1-3 herein are for illustration only, and the mode refinement methods and apparatus described herein will work with partial or fill decoder/encoder stages also, or even other configurations.

### 1. Mode Refinement

In one embodiment of the mode refinement processing referenced above, the skipped and non-skipped transitions are considered for all slices I, P, and B. For I slices only, however, other refinements are considered; i.e.:
1. Rechecking likely intra 4×4 mode from neighboring MB modes;
2. Rechecking likely intra 8×8 mode from neighboring MB modes; and
3. Intra 4×4, intra 8×8, and intra 16×16 transitions.
   It is noted that the intra 8×8 mode is valid only for High Profile of the H.264 video standard (ITU-T Recommendation No. H.264, “SERIES H: AUDIOVISUAL AND MULTIMEDIA SYSTEMS—Infrastructure of audiovisual services—Coding of moving Video—Advanced video coding for generic audiovisual services” dated November 2007, which is incorporated by reference herein in its entirety),
   a. Skipped and Non-Skipped Transitions

The following nomenclatures are used herein for purposes of illustration. If an MB is skipped, it can comprise one of three (3) exemplary logical states or conditions:
(1) “prior skip”—MB was skipped in the original bitstream prior to transrating, and may or may not remain skipped after transrating. For example, the relationship of Eqn. (1) may be used for this purpose:

priorSkip=(mbFlags[CUR]& MBF_SKIPPED)) Eqn (1)
(2) “new skip”—MB was not skipped in the original bitstream prior to transrating, and was converted to skipped after transrating. For example, the relationship of Eqn. (2) may be used for this purpose:

newSkip=!(mbFlags[CUR]& MBF_SKIPPED) && (mb_type==0) && (cbp[CUR]==0) Eqn (2)
(3) “remained skip” MB was skipped in the original bitstream prior to transrating, and remains skipped after transrating. For example, the relationship of Eqn. (3) may be used for this purpose:

remSkip=(mbFlags[CUR]& MBF_SKIPPED) && (cbp[CUR]==0). Eqn (3)

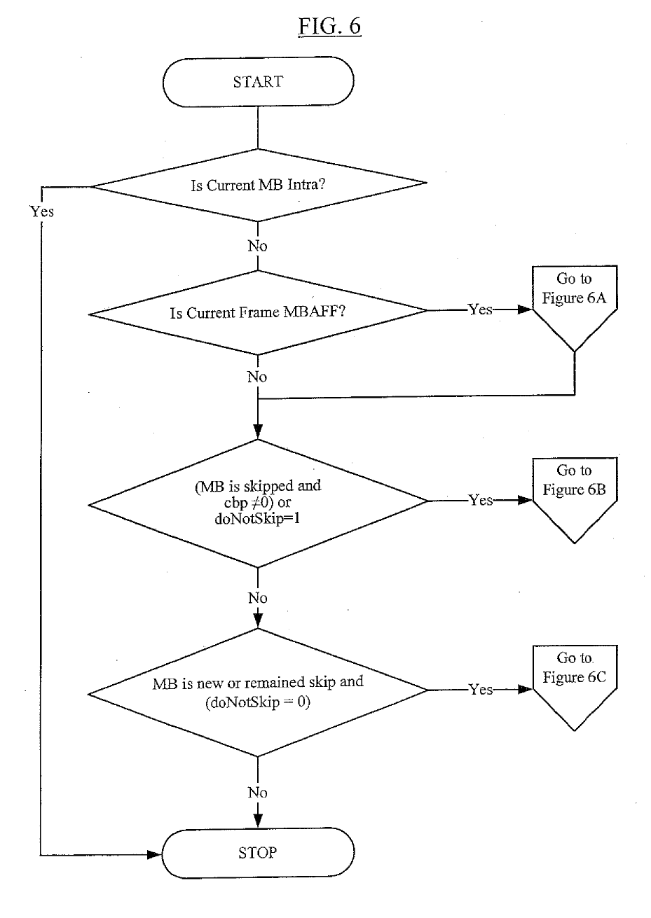

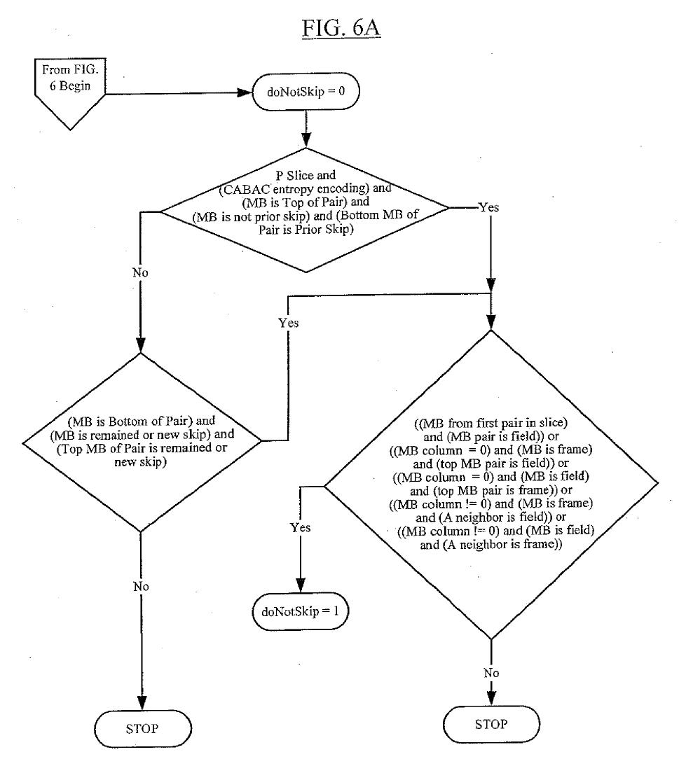

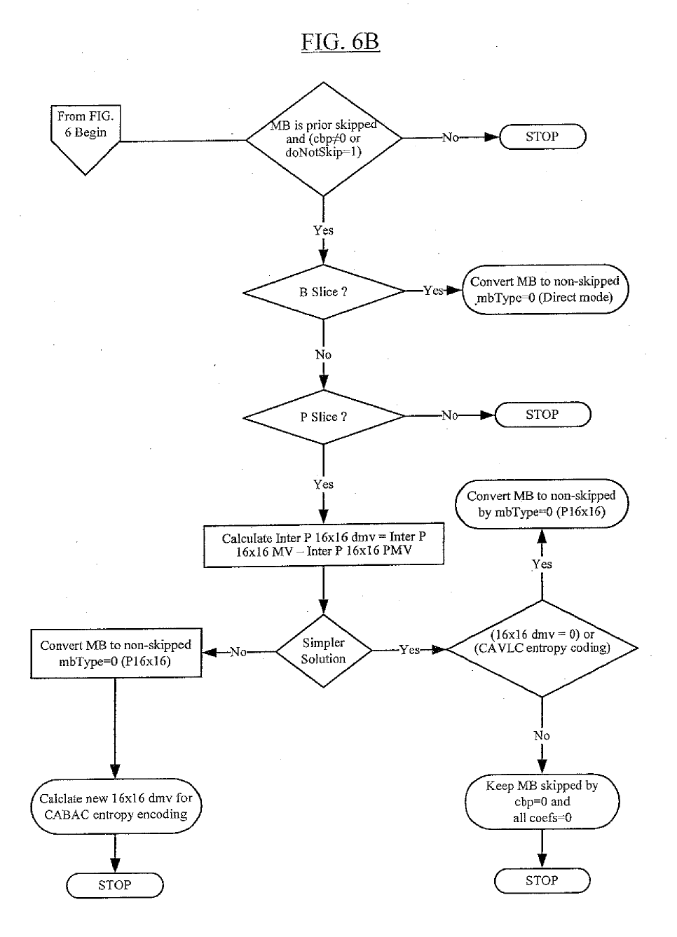

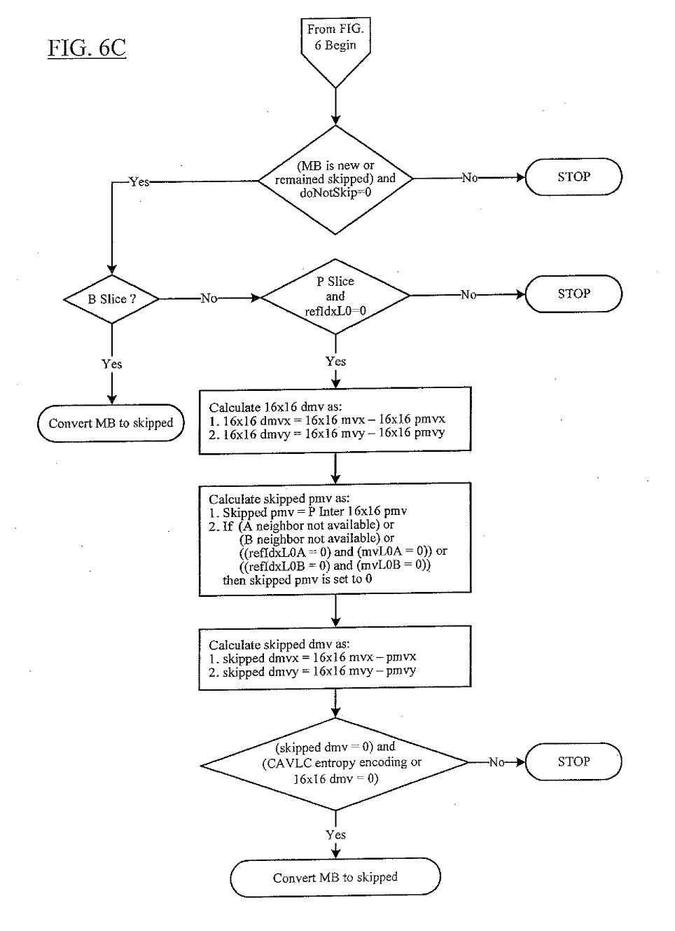

FIGS. 6-6c graphically illustrate exemplary embodiments of the methods of processing skipped and non-skipped transitions according to the invention. FIG. 6A shows one method of handling MBAFF doNotSkip Flag Settings; FIG. 6B shows one method of handling skipped to non-skipped transitions; and FIG. 6C shows one method of handling non-skipped to skipped transitions.

b. Do Not Skip Conditions for MBAFF

For Macroblock-adaptive frame-field (MBAFF) frames, if a macroblock pair from a P or B slice is converted from a skipped to a non-skipped state (or vice-versa), certain conditions (defined below) must be satisfied before it can be converted, or alternatively it can be kept in skipped mode (with no preconditions) in order to make sure that the inferred mb_field_decoding_flag during entropy coding is consistent. This test is referred to herein as the “skipped test”. The MB pair that needs to be tested for “skipped test” has to satisfy all criteria below, which are referred to as the “skipped test criteria”:
(1) the current MB pair is from an MBAFF frame,
(2) the top MB of the pair is “remained” or “new skip”, and
(3) the bottom MB of the pair is “remained” or “new skip”.

If an MB pair satisfies these three criteria, one of the MBs of the pair cannot be skipped if any of the following five (5) conditions hold for the current macroblock; these five conditions are referred to herein as the “do not skip conditions”:
(1) (Current MB is from first MB pair in slice) and (Current MB pair is “field”).
(2) (MB column=0) and (Current MB pair is “frame”) and (Top MB pair is “field”).
(3) (MB column=0) and (Current MB pair is “field”) and (Top MB pair is “frame”).
(4) (MB column !=0) and (Current MB pair is “frame”) and (A neighbor pair is “field”).
(5) (MB column !=0) and (Current MB pair is “field”) and (A neighbor pair is “frame”).
   The outcome of this “do not skip” test is doNotSkip=1 when one of the MBs of the pair cannot be converted to “skipped”, or alternatively doNotSkip=0, when either or both MBs of the pair can be converted to “skipped” (i.e., none of conditions (1) through (5) above hold).

For inter MBs from B slice, an MB can be converted from “skipped” to “non-skipped” and vice versa with no problem. For MBs from P slice, such conversion may not be possible as described below. So for inter MBs from B slice, the “do not skip test” can be deferred until the bottom MB of the pair. If the bottom MB is “remained” or “new skipped”, and doNotSkip=0, then the bottom MB can be kept or changed to “skipped”. If the bottom MB has doNotSkip=1, the bottom MB can be kept or changed to “non-skipped”.

For inter MBs from P slice, since they may not be able to be converted to “skipped” from “non-skipped” or vice versa for CABAC entropy encoding (see discussion of CABAC provided below), the “do not skip test” cannot be deferred until the bottom MB. This decision for the top MB of the pair must be taken based on the “skipped” status of the bottom MB.

The foregoing embodiment of the “do not skip test” logic for macroblocks from P or B slice can be summarized as follows:

```
Set doNotSkip = 0.
If Current Frame is MBAFF and MB is inter
    If (MB pair is from P slice) and (CABAC is entropy encoding) and (Current MB
is “Top of Pair”) and
      (Current MB is not prior skip) and (Bottom MB of Pair is “prior skip”), then
        If ((Current MB is first MB in slice) and (Current MB pair is “field”)) or
          ((MB column = 0) and (Current MB is “frame”) and (Top MB pair is
    “field”)) or
          ((MB column = 0) and (Current MB is “field”) and (Top MB pair is
    “frame”)) or
          ((MB column != 0) and (Current MB is “frame”) and (A neighbor pair is
    “field”)) or
          ((MB column != 0) and (Current MB is “field”) and (A neighbor pair is
        “frame”)), then
            Set doNotSkip = 1.
    Else If (Current MB is “Bottom of Pair”) and (Current MB is “remained” or “new skip”)
and
        (Top MB of Pair is “remained” or “new skip”)
        If ((Current MB is from first MB pair in slice) and (Current MB pair is
“field”)) or
          ((MB column = 0) and (Current MB is “frame”) and (Top MB pair is
    “field”)) or
          ((MB column = 0) and (Current MB is “field”) and (Top MB pair is
    “frame”)) or
          ((MB column != 0) and (Current MB is “frame”) and (A neighbor pair is
    “field”)) or
          ((MB column != 0) and (Current MB is “field”) and (A neighbor pair is
        “frame”)), then
    Set doNotSkip to 1.
```

c. Skipped to Non-Skipped Transitions

For P and B slices, an MB is converted from “skipped” to “non-skipped” if the following conditions hold:
1. The current MB is skipped, and cbp is non-zero after transrating, OR
2. doNotSkip=1.
   Here, the term “cbp” refers to the coded block pattern, which denotes the distribution of non-zero coefficients in a block. If the cbp from the macroblock is zero, it means that the entire macroblock has all zero coefficients.

If any these conditions are satisfied, the following is performed:
1. For B slices, convert the MB to “non-skipped” by changing the mb_type to 0 which is Direct mode.
2. For P slices, two scenarios exist: (i) simple, and (ii) complex. If CABAC entropy encoding is used, any recalculation of the dmvs (delta motion vectors) may result in the selection of a new context model or probability table for bin 1 in encoding the mvd (motion vector difference). Here, both dmv and mvd refers to the difference between a motion vector component to be used and its prediction. In one embodiment, the procedures set forth in H.264 standard previously incorporated herein is utilized for this determination. For example, Section 8.4.1.3 entitled “Derivation process for luma motion vector prediction” of H.264 may be used for the determination. See Appendix I hereto. There are two solutions possible here—(1) a simpler solution that does not require the selection of the new context model at the entropy encoder, and reuses the context model from the entropy decoder, and (2) a complex solution which uses the new dmvs to select new context models. The latter solution requires dmv information from the A and B neighbors. The two solutions have different ramifications on the skipped mode decision:

a. Simpler Solution:
(1) Calculate the Inter P 16×16 dmv=Inter P 16×16 MV—Inter P 16×16 PMV. Here PMV denotes the predicted motion vector determined as per the H.264 standard Section 8.4.1.3 entitled “Derivation process for luma motion vector prediction”. See Appendix I hereto.
(2) If (Inter P 16×16 dmv=0) or (CAVLC entropy encoding), then convert the MB to “non-skipped” by changing the mb_type to 0 (which is Inter P 16×16 mode).
(3) Otherwise, keep the MB as “skipped” by: (i) setting cbp for current MB to 0, and (ii) setting all coefficient blocks to 0.

b. Complex Solution:
(1) Calculate the Inter P 16×16 dmv=Inter P 16×16 MV—Inter P 16×16 PMV.
(2) Convert the MB to non-skipped by changing the mb_type to 0 (which is Inter P 16×16 mode).
(3) Use the new 16×16 dmv in the selection of a new context model or probability table for bin 1 in encoding the mvd for CABAC entropy encoding.
   d. Non-Skipped to Skipped Transitions

A macroblock in a P or B slice can be converted from “non-skipped” to “skipped” if the following conditions hold:
1. The current MB is “new” or “remained skip”, and
2. doNotSkip=0.

If these conditions are satisfied, the following is performed:
1. For B slices, convert the MB to “skipped”.
2. For P slices with LO reference index (refIdxL0)=0:
   a. Calculate Inter P 16×16 dmv=Inter P 16×16 motion vector—16×16 pmv (predicted motion vector, H.264 standard Section 8.4.1.3 entitled “Derivation process for luma motion vector prediction” and Appendix I hereto).
   b. Calculate the skipped pmv as follows:
      (1) The skipped pmv is set to Inter P 16×16 pmv, and
      (2) If (A neighbor not available) or
         (B neighbor not available) or
         ((refIdxL0A=0) and (mvL0A=0)) or
         ((refIdxL0B=0) and (mvL0B=0))
      then skipped pmv is set to 0.
   c. Calculate skipped dmv=Inter P 16×16 mv−skipped pmv.
   d. If (skipped dmv=0) and (CAVLC encoding or 16×16 dmv=0)
      then the MB is converted to “skipped”.
   e. Otherwise, the MB is left as “non-skipped” Inter P 16×16.

The foregoing embodiment of the “skipped to non-skipped” and “non-skipped to skipped” transition logic can be summarized by the following:

Set doNotSkip = 0.
If Current Picture is MBAFF
Find doNotSkip by method of Section b. above.
If ((Current MB is skipped) and (cbp is non-zero after
transrating)) or (doNotSkip = 1), then try converting
MB from “Skipped” to “Non-Skipped” by the method of Section c.
above.
If (Current MB is “new” or “remained skip”) and
(doNotSkip = 0), then try converting MB from “Non-Skipped”
to “Skipped” by the method of Section d. above.

e. Recheck Likely Intra 4×4 or Intra8×8 Modes

If the current 4×4 or 8×8 partition has the same intra 4×4 or 8×8 mode as t inferred mode, the bitstream carries three (3) less bits that store the mode of the partition in the rem_intra4×4_pred_mode field of the macroblock coding layer. The following process is used (for I pictures only):
1. Determine the intraM×MPredModeA and intraM×MPredModeB values of the neighboring 4×4 or 8×8 blocks. In one embodiment, the procedures set forth in the H.264 standard previously incorporated herein are utilized for these determinations. For example, Section 8.3.1.1 entitled “Derivation process for the Intra4×4PredMode” of H.264 may be used for Intra 4×4 determinations, and Section 8.3.2.1 entitled “Derivation process for the Intra8'8PredMode” may be used for Intra 8×8 determinations. See Appendix II and Appendix III hereto.
2. The inferred 4×4 or 8×8 mode is computed using Eqn. (4):

intraM×MPredMode=Min(intraM×MPredModeA, intraM×MPredModeB) Eqn (4)
3. If the current 4×4 or 8×8 block has the same mode as intraM×MPredMode, the current mode is maintained.
4. Otherwise, intra 4×4 or 8×8 prediction is performed according to the current mode and the intraM×MPredMode, and a check for the minimum (i) a sum of absolute differences (SAD), or (ii) a sum of absolute transformed differences (SATD) with the predicted block at the decoder stage is also performed. In one variant of the method, the mode that provides minimum SAD or SATD result is utilized, although it will be appreciated that other criteria may be applied in conjunction with or in place of the foregoing.

In various embodiments of the invention, p(i,j) represents the predicted pixels by the I₁ intra prediction module at the decoder stage of the A1 (FIG. 4 herein) or A1p (FIG. 5 herein) transraters. The value q(i,j) represents the predicted pixels by I₂ intra prediction module at the decoder stage of the A1 or A1p transraters. Then, the sum of absolute differences (SAD) is given by Eqn. (5), and the sum of absolute transformed differences (SATD) is given by Eqn. (6):

SAD=Sum_{i,j}|p(i,j)−q(i,j)| Eqn (5)

SATD=Sum_{i,j}|fTQ₂(p(i,j)−q(i,j))| Eqn (6)

f. Intra 4×4, Intra 8×8, and Intra16×16 Mode Transitions

Due to transrating, the level of quantization typically increases, and the macroblocks that previously had intra 4×4 can move to intra 8×8 or intra 16×16 modes. Furthermore, intra 8×8 mode MBs can transition to intra 16×16 modes. In order to determine whether such transitions are present, the following exemplary process is used (on I pictures only).

The process starts with default MB sizes for intra 8×8 (s8) and intra 16×16 MBs (s16) that are empirically determined based on the difference of the transrated and original quantization parameters. Specifically:

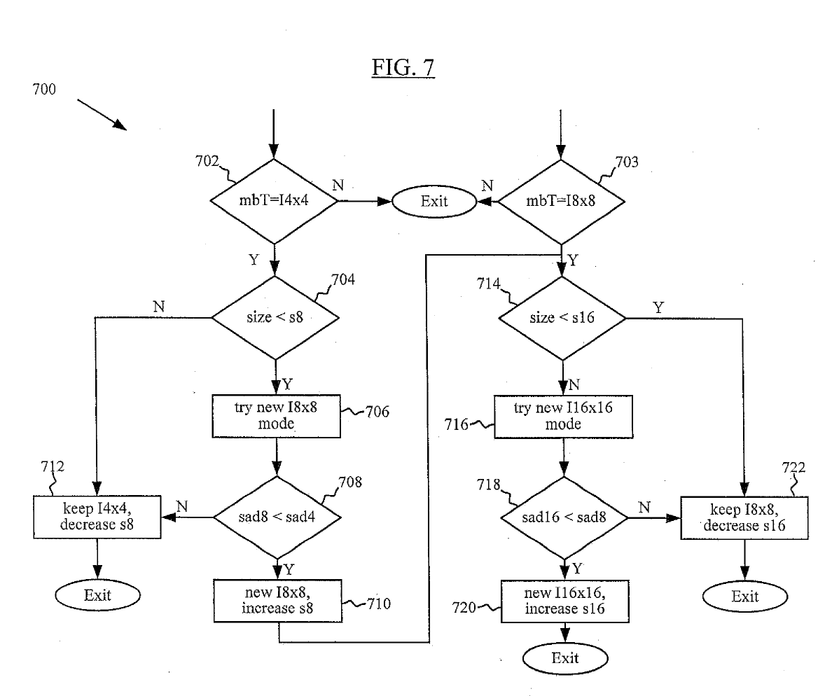

```
If I-slice
    If the original QP = transrated QP
        Keep current intra mode
    Else
        ΔQP = transrated QP − original QP
        s8 = func8(ΔQP)
        s16 = func16(ΔQP)
        Apply process 600 of Fig. 7.
```

FIG. 7 is a flowchart showing exemplary steps of intra mode decisions taken in accordance with one embodiment of the present invention. Step 702 of the method 700 is executed for intra 4×4 MBs, and step 703 is executed for intra 8×8 MBs. If in step 704, the size (in number of bits) of the encoded MB is deemed less than value of the parameter s8, then a new intra 8×8 mode encoding is tried in step 706 for the 8×8 MB that includes the MB currently being tested.

In step 708, the resulting error of encoding is compared with the encoding error of the original Intra 4×4 encoding. This error of encoding is sometimes referred to as “distortion error” caused by the encoding. The new encoding error is referred to as sad8 (sum of absolute differences) and the old encoding error is referred to as sad4. If the new encoding error is smaller, then the new encoding mode is used to encode the MB (step 710); otherwise, the intra 4×4 encoding mode for encoding the MB is kept (step 712), and the decision process ends.

If the original MB being tested for encoding mode is an intra 8×8 MB (step 703), or if a decision was made in step 710 to re-encode an MB to be an intra 8×8 MB, then a determination is made in step 714 regarding whether the resulting size in terms of number of encoded bits is smaller than value of the variable s16. If the size of the Intra 8×8 encoding is smaller than s16, then in step 722, a decision is made to encode the MB as an intra 8×8 MB. Otherwise, in step 716, the MB is encoded using intra 16×16 encoding type.

Next, the encoding error of this encoding (“distortion error”) is compared in step 718 with the error of encoding using intra 8×8 mode. If the error of intra 16×16 encoding is smaller than intra 8×8 error, then in step 720, the decision is made to encode the MB as an intra 16×16 MB. Otherwise, the MB is encoded as an intra 8×8 MB.

In the illustrated embodiment, the functions func8( ) and func16( ) referenced above are empirically determined. For decreasing or increasing s8 and s16, the constants α and β are used, where:

Decrease s8=(1−α)*s8 Eqn (7)

Increase s8=(1+α)*s8 Eqn (8)

The same approach is applied for s16 (with a different constant β). Here, α and β are in the present embodiment determined empirically. The SAD is the sum of absolute difference (SAD) between the newly predicted block and the original predicted block computed at the decoder stage of the transrator, i.e., the intra prediction module I₁ for the A1 (FIG. 4) or A1p (FIG. 5) transraters. SAD4 is the SAD of intra 4×4 prediction with the original prediction at the decoder stage. SAD8 is the SAD of intra 8×8 prediction with the original prediction at the decoder stage.

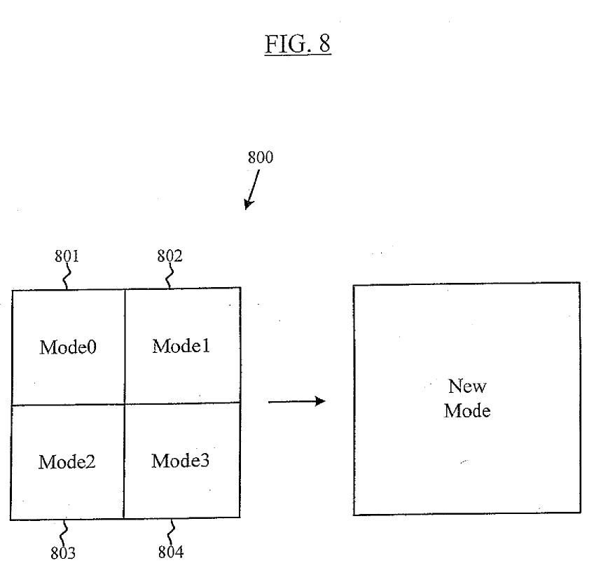

FIG. 8 illustrates that when re-encoding is performed because of mode decisions as described above, the transrater may have to decide a new mode for the re-encoded MB (which comprises four smaller parts 801, 802, 803, 804, each of which possibly had a separate encoding mode). For example, for 4 intra 4×4 blocks, there is one intra 8×8 block. Given four (4) intra 4×4 blocks, the result of the mode decision also needs to answer the question: what is the “new mode” of the intra 8×8 block?

If the most probable intra 8×8 mode (for example, as determined by Section 8.3.2.1 “Derivation process for the Intra8×8PredMode” of the H.264 standard as described previously herein; see Appendix III hereto) is one of the intra 4×4 modes, then that is chosen as the new intra 8×8 mode. Otherwise, if two or more of the modes are the same, that mode is chosen as the new intra 8×8 mode. Otherwise, the upper left corner mode (Mode 0) 801 of the box 800 of FIG. 8 as the new intra 8×8 mode.

For four (4) intra 8×8 blocks, there is one intra 16×16 block. Given 4 intra 8×8 blocks, the “new mode” of the intra 16×16 must be determined. If two or more of the modes is DC or horizontal or vertical (see H.264 standard Section 8.3.3 “Intra_{—}16×16 prediction process for luma samples” and Appendix IV hereto), then that DC Horizontal Vertical mode is chosen as the new intra 16×16 mode. Otherwise, the new intra 16×16 mode is selected as plane mode.

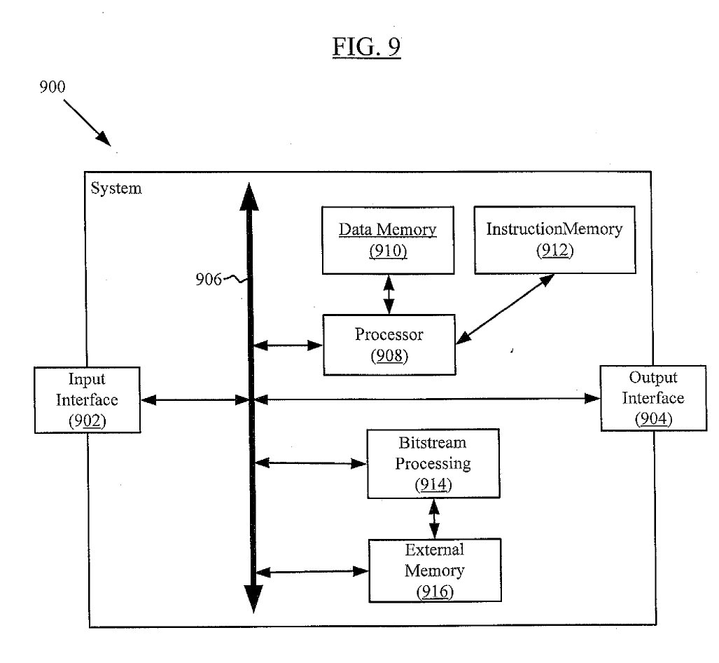

FIG. 9 shows an exemplary system-level apparatus 900, where one or more of the various mode refinement methods and transcoding/transrating apparatus of the present invention are implemented, such as by using a combination of hardware, firmware and/or software. This embodiment of the system 900 comprises an input interface 902 adapted to receive one or more video bitstreams, and an output interface 904 adapted to output a one or more transrated output bitstreams. The interfaces 902 and 904 may be embodied in the same physical interface (e.g., RJ-45 Ethernet interface, PCI/PIC-x bus, IEEE-Std. 1394 “FireWire”, USB, wireless interface such as PAN, WiFi (IEEE Std. 802.11, WiMAX (IEEE Std. 802.16), etc.). The video bitstream made available from the input interface 902 may be carried using an internal data bus 906 to various other implementation modules such as a processor 908 (e.g., DSP, RISC, CISC, array processor, etc.) having a data memory 910 an instruction memory 912, a bitstream processing module 914, and/or an external memory module 916 comprising computer-readable memory. In one embodiment, the bitstream processing module 914 is implemented in a field programmable gate array (FPGA). In another embodiment, the module 914 (and in fact the entire device 900) may be implemented in a system-on-chip (SoC) integrated circuit, whether on a single die or multiple die. The device 900 may also be implemented using board level integrated or discrete components. Any number of other different implementations will be recognized by those of ordinary skill in the hardware/firmware/software design arts, given the present disclosure, all such implementations being within the scope of the claims appended hereto.

In one exemplary software implementation, methods of the present invention are implemented as a computer program that is stored on a computer useable medium, such as a memory card, a digital versatile disk (DVD), a compact disc (CD), USB key, flash memory, optical disk, and so on. The computer readable program, when loaded on a computer or other processing device, implements the mode refinement, transcoding and/or transrating methodologies of the present invention.

It would be recognized by those skilled in the art, that the invention described herein can take the form of an entirely hardware embodiment, an entirely software embodiment, or an embodiment containing both hardware and software elements. In an exemplary embodiment, the invention may be implemented in software, which includes but is not limited to firmware, resident software, microcode, etc.

In this case, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

It will also be appreciated that while the above description of the various aspects of the invention are rendered in the context of particular architectures or configurations of hardware, software and/or firmware, these are merely exemplary and for purposes of illustration, and in no way limiting on the various implementations or forms the invention may take. For example, the functions of two or more “blocks” or modules may be integrated or combined, or conversely the functions of a single block or module may be divided into two or more components. Moreover, it will be recognized that certain of the functions of each configuration may be optional (or may be substituted for by other processes or functions) depending on the particular application.

It should be understood, of course, that the foregoing relates to exemplary embodiments of the invention and that modifications may be made without departing from the spirit and scope of the invention as set forth in the following claims.

### Appendix I—Exemplary H.264 Process for Luma Motion Vector Prediction Derivation

Inputs to theluma motion vector prediction process are:
(i) the macroblock partition index (i.e., mbPartIdx),
(ii) the sub-macroblock partition index (i.e., subMbPartIdx),
(iii) the reference index of the current partition (i.e, refIdxLX with X=0 or 1),
(iv) the variable currSubMbType.

The output of this prediction process comprises the prediction mvpLX of the motion vector mvLX (X=0 or 1). The neighboring block motion data derivation process is performed with mbPartIdx, subMbPartIdx, currSubMbType, and listSuffixFlag=X (X=0 or 1 for refIdxLX being refIdxL0 or refIdxL1, respectively) as the input, and with mbAddrN\mbPartIdxN\subMbPartIdxN, reference indices refIdxLXN and the motion vectors mvLXN (with N being replaced by A, B, or C as the output).

The median luma motion vector prediction derivation process for is performed with mbAddrN\mbPartIdxN\subMbPartIdN, mvLXN, refIdxLXN (with N being replaced by A, B, or C) and refIdxLX as the input, and mvpLX as the output, unless one or more of the following conditions is met:
(i) MbPartWidth(mb_type)=16, MbPartHeight(mb_type)=8, mbPartIdx=0, and refIdxLXB=refIdxLX,

mvpLX=mvLXB (AI-1)
(ii) MbPartWidth(mb_type)=16, MbPartHeight(mb_type)=8, mbPartIdx=1, and refIdxLXA=refIdxLX,

mvpLX=mvLXA (AI-2)
(iii) MbPartWidth(mb₌type)=8, MbPartHeight(mb_type)=16, mbPartIdx=0, and refIdxLXA=refIdxLX, or

mvpLX=mvLXA (AI-3)
(iv) MbPartWidth(mb_type)=8, MbPartHeight(mb_type)=16, mbPartIdx=1, and refIdxLXC=refIdxLX,

mvpLX=mvLXC (AI-4)

### Appendix II—Exemplary H.264 Method for Deriving Intra4×4PredMode

Inputs to the Intra4×4PredMode derivation process include the index of the 4×4 luma block luma4×4BlkIdx and variable arrays Intra4×4PredMode (where available) and Intra8×8PredMode (where available) that are previously obtained for adjacent macroblocks. The output of the Intra4×4PredMode derivation process is the variable Intra4×4PredMode[luma4×4BlkIdx].

The value for Intra4×4PredMode with its associated name are as follows:
0—Intra_{—}4×4Vertical (prediction mode);
1—Intra_{—}4×4Horizontal (prediction mode);
2—Intra_{—}4×4_DC (prediction mode);
3—Intra_{—}4×4_Diagonal_Down_Left (prediction mode);
4—Intra_{—}4×4_Diagonal_Down_Right prediction mode);
5—Intra_{—}4×4_Vertical_Right (prediction mode);
6—Intra_{—}4×4_Horizontal_Down (prediction mode);
7—Intra_{—}4×4_Vertical_Left (prediction mode);
8—Intra_{—}4×4_Horizontal_Up (prediction mode).
   The Intra4×4PredMode[luma4×4BlkIdx] is derived as follows.
The process specified in subclause 6.4.10.4 of H.264 (derivation process for neighboring 4×4 luma blocks) is invoked with luma4×4BlkIdx given as an input, and the output is assigned to mbAddrA, luma4×4BlkIdxA, mbAddrB, and luma4×4BlkIdxB.
dcPredModePredictedFlag is derived as follows.
   dcPredModePredicatedFlag will be set equal to 1 if:
      either of the macroblocks with the addresses mbAddrA or mbAddrB are unavailable;
      either of the macroblocks with addresses mbAddrA or mbAddrB are available and coded in Inter prediction mode, and constrained_intra_pred_flag is equal to 1.
   dcPredModePredictedFlag will be set equal to 0 if neither of the preceding conditions occurs.
The variable intraM×MPredModeN (for N being replaced by A or B) is derived as follows:
   If dcPredModePredictedFlag is equal to 1, then intraM×MPredModeN is set equal to 2 (intra_{—}4×4_DC prediction mode).
   If the macroblock with the address mbAddrN is not coded in Intra_{—}4×4 or Intra_{—}8×8 macroblock prediction mode, then intraM×MPredModeN is set equal to 2 (intra_{—}4×4_DC prediction mode).
   If neither of the above two conditions occur, then: dcPredModePredictedFlag is set equal to 0, and the macroblock with address mbAddrN is coded in Intra_{—}4×4 macroblock prediction mode or the macroblock with address mbAddrN is coded in Intra_{—}8×8 macroblock prediction mode.
      Also:
      If the macroblock addressed mbAddrN is coded in Intra_{—}4×4 macroblock mode, then intraM×MPredModeN is set equal to the value of Intra4×4PredMode[luma4×4BlkIdxN], where the Intra4×4PredMode is the variable array assigned to the macroblock mbAddrN.
      If the macroblock addressed mbAddrN is not coded in Intra_{—}4×4 macroblock mode (the macroblock with address mbAddrN is coded in Intra_{—}8×8 macroblock mode), then intraM×WredModeN is set equal to the value of Intra8×8PredMode[luma4×4BlkIdxN>>2], where Intra8×8PredMode is the variable array assigned to the macroblock mbAddrN.
The following procedure is used to derive Intra4×4PredMode[luma4×4BlkIdx]:
   predIntra4×4PredMode=Min(intraM×MPredModeA, intraM×MPredModeB)
   if(prev_intra4×4pred_mode_flag[luma4×4BlkIdx]) Intra4×4PredMode[luma4×4BlkIdx]=predIntra4×4PredMode
   else
      if (rem_intra4×4_pred_mode[luma4×4BlkIdx]<predIntra4×4PredMode)
         Intra4×4PredMode[luma4×4BIkIdx]=rem_intra4×4_pred_mode[luma4×4BlkIdx]
      else
         Intra4×4PredMode[luma4×4BlkIdx]=rem_intra4×4_red_mode[luma4×4BlkIdx]+1

### Appendix III—Exemplary H.264 Method for Prediction of a Sample Intra 4×4 Block

This process is utilized for each 4×4 luma block of a macroblock with prediction mode=Intra_{—}4×4, followed by the transform decoding and picture construction processes prior to deblocking for each 4×4 luma block.

The index of a 4×4 luma block luma4×4BlkIdx is the first input of the process. The second input is an (PicWidthInSamplesL)×(PicHeightInSamplesL) array cS_{L} containing constructed luma samples prior to the deblocking filter process of neighboring macroblocks.

Output of this process are the prediction samples pred4×4_{L}[x,y], with x,y=0..3 for the 4×4 luma block with index luma4×4BlkIdx.

By invoking the process described in paragraph 6.4.3 of H.264 (Inverse 4.4 luma block scanning process) with luma4×4BlkIdx as the input and the output being assigned to (xO, yO), the position of the upper-left sample of a 4×4 luma block with the index luma4×4BlkIdx inside the current macroblock is derived.

The thirteen neighboring samples p[x,y] that are constructed luma samples prior to the deblocking filter process, with x=−1, y=−1..3 and x=0..7, y=−1, are derived as follows:
Luma location (xN, yN) is specified by xN=Xo+x and yN=yO+y.
By invoking the process described in paragraph 6.4.11 of H.264 (Derivation process for neighboring locations) using luma locations (xN, yN) as inputs, outputs mbAddrN and (xW, yW).
Each sample p[x,y] with x=−1, y=−1..3 and x=0..7, y=−1 is derived by the following steps:
Sample p[x,y] is marked as “not available for Intra_{—}4×4 prediction when:
   mbAddrN is unavailable, or
   the macroblock mbAddrN is coded in Inter prediction mode and constrained_intra_pred_flag is equal to 1, or
   the macroblock mbAddrN has mb_type equal to SI and constrained_intra_pred_flag is equal to 1 and the current macroblock does not have mb_type equal to SI, or
   x>3 and luma4×4BlkIdx is equal to 3 or 11
If none of the above 4 scenarios occurs, sample p[x,y] is marked as “available for Intra_{—}4×4 prediction”
Then, the value sample p[x,y] is derived by:
   Derive the location of the upper-left luma sample of the macroblock mbAddrN by invoking the process described in paragraph 6.4.1 of H.264 (Inverse macroblock scanning process) where mbAddrN is the input and the output is assigned to (xM,yM).
   The sample value p[x,y] depends on MbaffFrameFlage and the macroblock mbAddrn and is determined as follows.
      If MbaffFrameFlag is equal to 1 and the macroblock mbAddrN is a field macroblock, then p[x,y]=cS_{L}[xM=xW,yM=2*yW]
      Else, p[x,y]=cS_{L}[xM=xW,yM+yW]

When the sample p[3, −1] is marked as “available for Intra_{—}4×4 prediction,” and samples p[x,−1], with x=4..7 are marked as “not available for Intra_{—}4×4 prediction,” the sample value of p[3,−1] is substituted for sample values p[x,−1], with x=4..7 and samples p[x,−1], with x=4..7 are marked as “available for Intra_{—}4×4 prediction”

One of the Intra_{—}4×4 prediction modes specified in paragraphs 8.3.1.2.1 through 8.3.1.2.9 of H.264 is invoked depending on Intra4×4PredMode[luma4×4BlkIdx].

### Appendix IV—Exemplary H.264 Luma Sample Intra 16×16 Prediction Process

The following process is used when the macroblock prediction mode=Intra_{—}16×16, and specifies how the Intraprediction luma samples for the current macroblock are determined. The input to the pluma sample rediction process is a (PicWidthInSamplesL)×(PicHeightInSamplesL) array cSL containing luma samples prior to the deblocking filter process of neighboring macroblocks, whileoutputs of the process are Intra prediction luma samples for the current macroblock predL[x, y].

The neighboring samples p[x, y] that are constructed luma samples prior to the deblocking filter process, with x=−1, y=−1..15 and with x=0..15, y=−1, are obtained as follows.
(i) The derivation process for neighboring locations set forth in Section 6.4.11 of H.264 is used for luma locations with (x, y) assigned to (xN, yN) as input. mbAddrN and (xW, yW) are outputs to this process.
(ii) Each sample p[x,y] with x=−1, y=−1..15 and with x=0..15, y=−1 is obtained as follows.
   (a) If any of the following conditions are true, the sample p[x, y] is identified as “not available for Intra_{—}16×16 prediction”:
      mbAddrN is not available,
      the macroblock mbAddrN is coded in Inter prediction mode and constrained_intra_pred_flag=1.
      the macroblock mbAddrN has mb_type=SI, and constrained_intra_pred_flag=1.
   (b) Otherwise, the sample p[x, y] is marked as “available for Intra_{—}16×16 prediction” and the value for p[x, y] is obtained as follows.
      The location of the upper-left luma sample of the macroblock mbAddrN is derived via the inverse macroblock scanning process of Section 6.4.1 with mbAddrN as the input, and (xM, yM) as the output.
      Depending on MbaffFrameFlag and the macroblock mbAddrN, the sample value p[x, y] is obtained as follows:
         If MbaffFrameFlag=1 and the macroblock mbAddrN is a field macroblock,

p[x, y]=cSL[xM+xW, yM+2*yW] (AIV-1)
Otherwise (MbaffFrameFlag=0, or the macroblock mbAddrN is a frame macroblock),

p[x, y]=cSL[xM+xW, yM+yW] (AIV-2)

predL[x, y] with x, y=0..15 is used to represent the prediction samples for the 16×16 luma block samples. Intra_{—}16×16 prediction modes are specified as follows:
Intra16×16PredMode 0=Intra_{—}16×16_Vertical (prediction mode)
Intra16×16PredMode 1=Intra_{—}16×16_Horizontal (prediction mode)
Intra16×16PredMode 2=Intra_{—}16×16_DC (prediction mode)
Intra16×16PredMode 3=Intra_{—}16×16_Plane (prediction mode)

Depending on the value of Intra16×16PredMode, one of the Intra_{—}16×16 prediction modes specified in Sections 8.3.3.1 to 8.3.3.4 of H.264 is applied.

What is claimed:

1. A method of transrating a digital video picture, comprising:
representing the digital video picture as a plurality of input macroblocks, each said input macroblock having at least first and second attributes; and
generating, corresponding to each input macroblock, an output macroblock, each of said output macroblocks having said at least first and second attributes;
wherein for each output macroblock having a first value for the first attribute, the second attribute is decided at least in part by evaluating one or more error criteria, said one or more error criteria responsive to the second attribute of a corresponding input macroblock.

2. The method of claim 1, wherein:
each of said input macroblocks and output macroblocks comprises a third attribute; and
the third attribute of the output macroblock is responsive to a spatial and a temporal location of the output macroblock.

3. The method of claim 2, wherein the digital video picture comprises a picture encoding attribute.

4. The method of claim 2, wherein said first attribute comprises a slice type, said second attribute comprises an encoding mode, and said third attribute comprises a skipped mode.

5. The method of claim 4, wherein the skipped mode is one of skipped and non-skipped.

6. The method of claim 4, wherein if the encoding mode is of a first predetermined type, then the skipped mode of the output macroblock is further responsive to the skipped mode of a second input macroblock.

7. The method of claim 6, wherein the input macroblock and the second input macroblock together comprise spatially co-located top and bottom macroblocks in the digital video picture.

8. The method of claim 1, wherein said first attribute comprises a slice type, and said second attribute comprises an encoding mode.

9. The method of claim 1, wherein said first value indicates a slice type relating to an intra prediction.

10. The method of claim 1, wherein the one or more error criteria comprises one of: (i) a sum of absolute differences (SAD), or (ii) a sum of absolute transformed differences (SATD), between the input macroblock and the output macroblock.

11. A computer-implemented method of processing a macroblock of an input video picture, comprising:
if the input video picture is intra encoded then assigning an intra encoding mode for the macroblock by at least:
calculating a transrating error for a plurality of candidate output macroblocks having an intra encoding mode; and
assigning to the macroblock the intra encoding mode of a candidate output macroblock having the minimum value of said transrating error; and
if the input video picture is not intra encoded, then encoding the macroblock as a skipped macroblock based at least in part on at least first, second and third attributes associated with the macroblock.

12. The method of claim 11, wherein said first second and third attributes comprise: (i) a spatial position of the macroblock, (ii) a top/bottom polarity of the macroblock, and (iii) a run length encoding scheme used for encoding the macroblock, respectively.

13. The method of claim 12, wherein the run length encoding scheme comprises a context adaptive binary arithmetic coding scheme (CABAC).

14. The method of claim 13, wherein the run length encoding scheme comprises an H.264 codec scheme.

15. The method of claim 11, wherein at least one of the plurality of candidate output macroblocks has a pixel width greater than a pixel width of the macroblock.

16. The method of claim 11, wherein at least one of the plurality of candidate output macroblocks has a pixel width twice that of a pixel width of the macroblock.

17. Apparatus configured to process a digital video image, said image represented as a plurality of input macroblocks, each said input macroblock having at least first and second attributes, said apparatus comprising:
a first interface adapted to receive at least said input macroblocks of said image;
logic configured to generate, corresponding to each input macroblock, an output macroblock, each of said output macroblocks having said at least first and second attributes; and
a second interface adapted to output at least said output macroblocks to a device;
wherein for each output macroblock having a first value for the first attribute, the second attribute is decided by said logic at least in part through evaluation of one or more error criteria, said one or more error criteria being related to the second attribute of a corresponding input macroblock.

18. The apparatus of claim 17, wherein each of said output macroblocks comprises a third attribute responsive to a spatial and a temporal location of that output macroblock.

19. The apparatus of claim 18, wherein the digital video image comprises an image encoding attribute.

20. The apparatus of claim 18, wherein said first attribute comprises a slice type, said second attribute comprises an encoding mode, and said third attribute comprises a skip mode.

21. The apparatus of claim 20, wherein the skip mode is selected from the group consiting of: (i) a skipped mode; and (ii) a non-skipped mode.

22. The apparatus of claim 20, wherein if the encoding mode is of a first predetermined type, then the skip mode of the output macroblock is further responsive to a skip mode of a second input macroblock.

23. The apparatus of claim 22, wherein the input macroblock and the second input macroblock together comprise spatially co-located top and bottom macroblocks in the digital video image.

24. The apparatus of claim 17, wherein said first attribute comprises a slice type, and said second attribute comprises an encoding mode; and
wherein said first value indicates a slice type relating to an intra prediction.

25. The apparatus of claim 17, wherein the one or more error criteria comprises at least one of: (i) a sum of absolute differences (SAD) between the input macroblock and the output macroblock, or (ii) a sum of absolute transformed differences (SATD) between the input macroblock and the output macroblock.

26. The apparatus of claim 17, wherein said first interface comprises a high-speed serialized bus protocol interface.

27. The apparatus of claim 17, wherein at least a portion of said logic is hard-coded into an integrated circuit of said apparatus.

28. The apparatus of claim 17, wherein said apparatus comprises a portable media device (PMD) having a battery and a display device, said display device allowing for viewing of said processed digital image.

29. The apparatus of claim 28, wherein said PMD further comprises NAND flash memory adapted to store said processed digital image.

30. An integrated circuit comprising:
at least one semi-conductive die;
a first interface adapted to receive data relating to one or more video images represented as a plurality of input macroblocks, each said input macroblock having at least first and second attributes;
at least one of computer instructions, firmware or hardware configured to generate, corresponding to each input macroblock, an output macroblock having said at least first and second attributes; and
a second interface adapted to output at least said output macroblocks;
wherein for macroblocks having a first value for the first attribute, the second attribute is decided by said at least one of computer instructions, firmware or hardware at least in part through evaluation error criteria related to the second attribute of a corresponding input macroblock.

31. The integrated circuit of claim 30, wherein said at least one semi-conductive die comprises a single silicon-based die, and said integrated circuit comprises a system-on-chip (SoC) integrated circuit having at least one digital processor in communication with a memory, and said first and second interfaces, processor and memory are all disposed on said single die.

32. A method of transrating video content comprising a plurality of macroblocks, the method comprising:
receiving said plurality of input macroblocks;
replacing exact transrating calculations relating to processing said macroblocks with approximations, said approximations requiring less resources to generate than said exact calculations; and
generating a plurality of transrated output macroblocks based at least in part on said plurality of input macroblocks and said approximations;
wherein said visual quality of the transrated output macroblocks is not perceptibly degraded with respect to the visual quality of transrated output macroblocks generated using said exact calculations.
